(19) United States
(12) Patent Application Publication
(10) Pub. No.: US 2026/0297269 A1
(43) Pub. Date: Oct. 1, 2026

(54) METHODS FOR PRODUCING RUBBER COMPOSITIONS AND ARTICLES THEREOF

(71) Applicant: The Goodyear Tire & Rubber Company, Akron, OH (US)

(72) Inventors: Robert Vincent Dennis-Pelcher, Uniontown, OH (US); Ryan Michael Schmidt, Wadsworth, OH (US); Daniel Lopez Gaxiola, Tallmadge, OH (US)

(21) Appl. No.: 19/575,074

(22) Filed: Mar. 23, 2026

Related U.S. Application Data
(60) Provisional application No. 63/778,482, filed on Mar. 27, 2025.

(51) Int. Cl. C08J 3/22; B60C 1/00; C08K 3/04; C08K 3/36

(52) U.S. Cl. CPC C08J 3/22; B60C 1/0016; B60C 1/0025; C08K 3/042; C08K 3/36; C08J 2307/00; C08J 2309/06; C08J 2409/00; C08J 2409/06

(57) ABSTRACT

In one aspect, the disclosure relates to a method for mixing rubber, comprising: combining together a first diene elastomer and a polymer masterbatch, thereby forming an initial mixture; wherein the polymer masterbatch comprises from about 1 phr to about 25 phr of a turbostratic graphene and a second diene elastomer. Also disclosed herein are articles produced using the disclosed methods, such as tires or components of tires. This abstract is intended as a scanning tool for purposes of searching in the particular art and is not intended to be limiting of the present disclosure.

### BACKGROUND

The demand for improved tire performance has resulted in the development and evaluation of new materials that can be used to form rubber articles with desirable properties. Improving tire properties such as rolling resistance while maintaining balances in tradeoffs can be challenging. For example, additives that improve hysteresis properties of a rubber article, such as rebound, can also result in reduction in thermal conductivity and/or an increase in abrasion loss. There is a need for rubber formulations that strike a balance between rheological properties such as hysteresis, stiffness, abrasion loss, and thermal conductivity. These needs and other needs are satisfied by the present disclosure.

### SUMMARY

In accordance with the purpose(s) of the disclosure, as embodied and broadly described herein, the disclosure, in one aspect, relates to a method for mixing rubber, comprising: combining together a first diene elastomer and a polymer masterbatch, thereby forming an initial mixture; wherein the polymer masterbatch comprises from about 1 phr to about 25 phr of a turbostratic graphene and a second diene elastomer. Also disclosed herein are articles produced using the disclosed methods, such as tires or components of tires. This abstract is intended as a scanning tool for purposes of searching in the particular art and is not intended to be limiting of the present disclosure

Other systems, methods, features, and advantages of the present disclosure will be or become apparent to one with skill in the art upon examination of the following detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### DETAILED DESCRIPTION

Many modifications and other aspects disclosed herein will come to mind to one skilled in the art to which the disclosed compositions and methods pertain having the benefit of the teachings presented in the foregoing descriptions. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein. Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein. Embodiments of the present disclosure will employ, unless otherwise indicated, techniques of material chemistry, organic chemistry, rubber mixing, rubber compounding, and the like, which are within the skill of the art. Such techniques are explained fully in the literature.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical compound, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “an elastomer,” “a polymer masterbatch,” or “a compound,” includes, but is not limited to, two or more such elastomers, polymer masterbatches, or compounds, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein.

The terms “alkoxy” and “alkoxyl” as used herein refer to an alkyl or cycloalkyl group bonded through an ether linkage; that is, an “alkoxy” group can be defined as -OA¹ where A¹ is alkyl as defined above.

As used herein, the terms “optional” or “optionally” means that the subsequently described event or circumstance can or cannot occur, and that the description includes instances where said event or circumstance occurs and instances where it does not.

The terms “rubber” and “elastomer” may be used herein interchangeably, unless indicated otherwise.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers/elastomers is in accordance with claimed phr ranges and the amount of all rubbers/elastomers in the composition results in total in 100 parts of rubber/elastomer.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In some aspects, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In another aspect, rubber compositions can be cured in molds in order to form finished articles including, but not limited to, tires.

As used herein, the term “repeat unit” as referenced in the elastomers described herein are derived from monomers used to produce the partially saturated elastomers. For example, polybutadiene has the repeat unit as provided below.

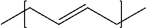

In certain aspects, when the elastomer is the polymerization product of two different monomers (e.g., A and B), the repeat unit can be represented by -A-B-.

As used herein, a “residue” of a chemical species refers to the moiety that is the resulting product of the chemical species in a particular reaction scheme or subsequent formulation or chemical product, regardless of whether the moiety is actually obtained from the chemical species. Thus, an isoprene residue in an elastomer refers to one or more —CH₂CH═C(CH₃)CH₂-units in the elastomer, regardless of whether isoprene was used to prepare the elastomer. Similarly, a butadiene residue in an elastomer refers to one or more —CH₂CH═CHCH₂— moieties in the elastomer, regardless of whether the residue is obtained by reacting sebacic acid or an ester thereof to obtain the polyester.

Unless otherwise specified, temperatures referred to herein are based on atmospheric pressure (i.e. one atmosphere).

B. ABBREVIATIONS

| | |
|---|---|
| ARES | advanced rheometric expansion system |
| MDR | moving die rheometer |
| RPA | rubber process analyzer |
| TD | tan delta |

### C. RUBBER COMPOSITIONS AND METHODS OF MAKING

In one aspect, the disclosure relates to compositions, such as uncured or cured/vulcanized rubber compositions, comprising a first diene elastomer and from about 1 phr to about 25 phr of a turbostratic graphene. In another aspect, disclosed herein is a method for mixing rubber comprising combining together a first diene elastomer and a polymer masterbatch, thereby forming an initial mixture. In one aspect, the polymer masterbatch comprises from about 1 phr to about 25 phr of a turbostratic graphene and a second diene elastomer. In a further aspect, the polymer masterbatch can comprise from about 20% to about 40%, about 20% to about 35%, about 20% to about 30%, about 25% to about 40%, about 30% to about 40%, or about 25% to about 35% of the turbostratic graphene by weight. In another aspect, the polymer masterbatch can comprise from about 1 phr to about 25 phr, about 1 phr to about 20 phr, about 1 phr to about 15 phr, about 1 phr to about 10 phr, about 3 phr to about 25 phr, about 3 phr to about 20 phr, about 3 phr to about 15 phr, or about 3 phr to about 10 phr of the turbostratic graphene. The compositions formed by the methods disclosed herein can exhibit good tear resistance, abrasion resistance, thermal conductivity, and compound stiffness. The present disclosure also relates to articles, such as tires and/or components of tires, comprising the disclosed compositions.

Turbostratic graphene differs structurally from other types of graphene, (e.g., AB-stacked graphene). In one aspect, turbostratic graphene does not comprise significant quantities of oxygen. In one aspect, turbostratic graphene comprises less than about 25%, less than about 20%, less than about 15%, less than about 10%, or less than about 5% oxygen by weight. In another aspect, turbostratic graphene can comprise from about 0.1% to about 25%, about 0.1% to about 20%, about 0.1% to about 15%, or about 0.1% to about 10% oxygen by weight. In another aspect, turbostratic graphene can comprise no oxygen. Turbostratic graphene can comprise more than about 75%, about 80%, about 85%, about 90%, or about 95% carbon by weight. In another aspect, turbostratic graphene can comprise from about 75% to about 100%, about 80% to about 100%, about 85% to about 100%, about 90% to about 100%, or about 95% to about 100% carbon by weight. One method of producing turbostratic graphene is described in WIPO International Publication No. 2021/068087 and in WIPO International Publication No. 2020/051000, which are each incorporated herein by reference in their entireties. Turbostratic graphene made in accordance with these applications is made from waste products, including used tires, which can be advantageous. Turbostratic graphene made in accordance with these Publications is available from Universal Matter.

Generally, in graphene, carbon atoms are bonded to one another to form a hexagon shaped lattice. Placing one layer of graphene atoms on top of another layer of graphene atoms forms a bilayer of graphene. Normally, adjacent atomic layers are arranged in one of two positions, referred to as AA-stacked graphene and AB-stacked graphene. In AA-stacking, the geometric centers of the hexagons of carbon atoms are organized immediately above one another. In AB-stacking, the hexagons of carbon atoms are displaced relative to one another so that the geometric centers of the hexagons of carbon atoms in adjacent layers are not centered above one another. This amounts to a shift of one-half a length dimension of a hexagon of carbon atoms relative to AA-stacked layers. In turbostratic graphene, the graphene includes particles in which adjacent carbon layers are more disordered than either AA- or AB-stacking. In turbostratic graphene, there is a random orientation of layers that may be referred to as twisted, rotated, weakly coupled, rotationally faulted, and/or misoriented. Rather than an ordered stack of platelets in which the face of each layer is stacked neatly against a face of an adjacent layer, the platelets may be stacked edge-to-face and/or shifted or rotated in one or more directions so that they are out of alignment face-to-face. An average interlayer spacing between adjacent graphene layers can be increased for turbostratic graphene relative to AA-stacked or AB-stacked graphene. In one aspect, the interlayer spacing for turbostratic graphene can range from about 3.40 Å to about 3.45 Å. By comparison, the interlayer spacing of AB-stacked graphene is about 3.37 Å and the interlayer spacing of AA-stacked graphene is believed to be slightly greater than the interlayer spacing of AB-stacked graphene.

The turbostratic graphene can be in the form of turbostratic graphene particles. The width and length dimensions of the particles can individually range from about 10 nm to about 10 μm or about 200 nm to about 5 μm, where width and length are measured in the plane of the hexagonal rings of carbon. In one aspect, in the height or thickness dimension (measured perpendicular to the length and width of hexagonal rings of carbon), the turbostratic graphene particles can be a few angstroms thick (e.g., less than 10 Å). In another aspect, the turbostratic graphene particles can comprise multiple layers of graphene. For example, each particle can include from 2 to 10 layers or from 2 to 5 layers of graphene.

Raman spectroscopy can be used to characterize the microstructure of graphene. For example, a ratio of the 2D-band peak intensity (12D, located around 2685 cm-1) to the G-band peak intensity (IG, located around 1582 cm-1), 12D/IG, can be measured to characterize defect density and/or graphene structure. Turbostratic graphene can have an 12D/IG ratio of at least about 0.5, at least about 1, at least about 5, at least about 10, or at least about 15. In another aspect, turbostratic graphene can have an 2D/IG ratio of from about 0.5 to about 17 or about 1 to about 17. The 12D/IG ratio for turbostratic graphene can be higher than it is for traditional AB-stacked graphene produced from mechanical, chemical, and/or thermal methods known in the art. The defect density can also be characterized via the ratio of the D-band peak intensity (Ip, located around 1350 cm-1) to IG, Ip/IG. In one aspect, turbostratic graphene can have an Ip/IG ratio of no more than about 1 or no more than about 0.5. In another aspect, turbostratic graphene can have an Ip/IG ratio of from about 0.01 to about 1, about 0.01 to about 0.8, about 0.01 to about 0.5, or about 0.01 to about 0.3. Turbostratic graphene can also be characterized by a unique Raman spectrum. In one aspect, turbostratic graphene can have peaks at 1880 cm-1 and 2030 cm-1. Turbostratic graphene may also not have a peak present at 1750 cm-1.

In one aspect, the first diene elastomer and the second diene elastomer can be the same. In another aspect, the first diene elastomer can be different from the second diene elastomer. In another aspect, the method can comprise combining together the first diene elastomer, the second diene elastomer, and the polymer masterbatch to form the initial mixture. In a further aspect, the polymer masterbatch can comprise the turbostratic graphene and the first diene elastomer, the second diene elastomer, or a combination thereof. Either one of the first diene elastomer and/or the second can comprise repeat units formed from residues of monomers selected from ethylene, propylene, isobutene, butadiene, isoprene, styrene, and acrylonitrile, and a combination thereof. In another aspect, the first diene elastomer and/or the second diene elastomer can comprise from about 90 wt % to about 99 wt % residues of cis-butadiene. In another aspect, the first diene elastomer and/or the second diene elastomer can comprise residues of isoprene (e.g., natural rubber). In a further aspect, the elastomers can have a number average molecular weight (Mn) between 100,000 Da and 500,000 Da. Mn may be determined by methods known in the art, such as by gel permeation chromatography following ASTM D3536 or equivalent.

In another aspect, the method can further comprise combining together at least one of a filler, an antidegradant, a resin, a coupling agent or a processing oil to form the initial mixture. In another aspect, the method can further comprising adding at least one of a filler, an antidegradant, a resin, a coupling agent or a processing oil to the initial mixture after its formation. The filler can be selected from carbon black, a precipitated silica, or a combination thereof. In one aspect, the method can comprise using from about 1 phr to about 150 phr of the precipitated silica. In another aspect, the method can comprise using from about 0.5 phr to about 150 phr, about 0.5 phr to about 100 phr, about 0.5 phr to about 50 phr, about 0.5 phr to about 25 phr, or about 0.5 phr to about 10 phr of carbon black. In another aspect, the method can comprise using from about 1 phr to about 10 phr, about 1 phr to about 5 phr, or about 5 phr to about 10 phr of the antidegradant. In another aspect, the method can comprise using from about 1 phr to about 30 phr, about 1 phr to about 20 phr, or about 1 phr to about 10 phr of the resin. In another aspect, the method can comprise using from about 1 phr to about 10 phr, about 1 phr to about 5 phr, or about 5 phr to about 10 phr of the coupling agent. In another aspect, the method can comprise using from about 1 phr to about 50 phr, about 1 phr to about 40 phr, about 1 phr to about 30 phr, or about 1 phr to about 20 phr of the processing oil.

The precipitated silica can include precipitated silicas obtained by the acidification of a soluble silicate, e.g., sodium silicate. The silica can be characterized by a Brunauer-Emmett-Teller (BET) surface area, as measured using nitrogen gas. In one aspect, the BET surface area can be in the range of about 40 m²/g to about 600 m²/g or about 80 m²/g to about 300 m²/g. The BET method of measuring surface area is described in the Journal of the American Chemical Society, Volume 60, Page 304 (1930). In a further aspect, the silica can be characterized by having a dibutylphthalate (DBP) absorption value in a range of about 100 cm³/g to about 400 cm³/g or about 150 cm³/g to about 300 cm³/g. In one aspect, the conventional silica can have an average ultimate particle size in the range of about 0.01 μm to about 0.05 μm as determined by an electron microscope. In other aspects, the silica particles can be smaller than 0.01 μm. In other aspects, the silica particles can be larger than 0.05 μm.

Antidegradants can include antioxidants and antiozonants. Representative antioxidants include, but are not limited to, phenylene diamine compounds (e.g., diphenyl-p-phenylenediamine), hydroquinoline compounds (e.g., anti-polymerized trimethyl dihydroquinoline), amine compounds, dithiocarbamate compounds, phenolic compounds, phosphite compounds, toluimidazole compounds, and others, such as those disclosed in The Vanderbilt Rubber Handbook (1978), Pages 344 through 346. Representative antiozonants include, but are not limited to, N-phenyl-N′-(1,3-dimethylbutyl)-p-phenylenediamine (6PPD) and N,N′-dixylene-p-phenylenediamine (DTPD).

The resin can include aromatic or nonaromatic hydrocarbon resins. The hydrocarbon resins can also have various degrees of unsaturation or be fully saturated. In one aspect, the resins can be derived from C5 alkenes and/or C9 alkenes. In another aspect, the hydrocarbon resin can be a terpene resin (e.g., a terpene polymer) derived from monomer terpene units such as limonene, α-pinene, β-pinene, and/or the like. In a further aspect, the resin can be a hydrocarbon resin selected from C5 aliphatic resins, C9 aromatic resins, terpene resins, and any combination thereof.

The coupling agent can include organosilane compounds such as bifunctional organosilanes. In a further aspect, the coupling agent can include mercapto silanes, blocked mercapto silanes, trialkoxymercaptoalkyl silanes, derivatives thereof, or combinations thereof. Mercapto silanes can include compounds such as 3-mercaptopropyl trialkoxy silanes, 3-mercaptopropyl dialkoxy (alkoxy) silanes, 3-mercaptoethyl trialkoxy silanes, or 3-mercaptoethyl dialkoxy (alkoxy) silanes, where the alkoxy groups can be a C1-C5 or C1-C3 alkoxy. Specific examples include, but are not limited to, 3-mercaptopropyltrimethoxy silane, 3-mercaptopropyldimethylmethoxysilane, 3-mercaptopropyldimethylethoxy silane, 3-mercaptopropylmethyldimethoxy silane, 3-mercaptopropylmethyldiethoxy silane, 3-mercaptodimethylmethoxy silane, 3-mercaptodimethylethoxy silane, 3-mercaptopehtyltriethoxy silane, or a combination thereof.

The processing oil can be included in the composition as an extending oil typically used to extend elastomers. The processing oil can also be included in the elastomer composition by addition of the oil directly during rubber compounding. The processing oil used can include both an extending oil present in the elastomers and a process oil added during compounding. Suitable processing oils include, but are not limited to, various oils as are known in the art, including aromatic, paraffinic, naphthenic, vegetable oils, and low PCA oils, such as MES, TDAE, SRAE, and heavy naphthenic oils. Suitable vegetable oils include, for example, soybean oil, sunflower oil, and canola oil which are in the form of esters containing a certain degree of unsaturation.

The method can comprise adding additional components in forming the initial mixture or to the initial mixture after formation, such as fatty acids, curing aids (e.g., activators, accelerators, retarders), and/or curing or vulcanizing agents. Fatty acids can be included in amounts of about 0.5 phr to about 3 phr. Examples of fatty acids include, but are not limited to, stearic acid, palmitic acids, oleic acid, and mixtures thereof. Activators can be included in amounts of about 1 phr to about 10 phr or about 1 phr to about 5 phr. Activators can include, but are not limited to, magnesium oxide, zinc oxide, calcium oxide, and polyethylene glycol. Accelerators and retarders can be individually included in amounts of about 1 phr to about 10 phr. Accelerators can include, but are not limited to, sulfenamide compounds (e.g., N-cyclohexyl-2-benzothiazolesulfenamide and N-tertbutyl-2-benzothiazolesulfenamide), guanidine compounds (e.g., diphenylguanidine), dithiocarbamate compounds, thiadiazol compounds, thiazole compounds, thiourea compounds, thiuram compound, and xanthate compounds. Retarders can include, but are not limited to, phthalic anhydrides, phthalimides (e.g., N-(cyclohexylthio) phthalimide), sulfenamide compounds, and acids (e.g., benzoic acid and salicylic acid). Vulcanizing agents can be included in amounts of about 0.1 phr to about 8.0 phr or about 0.1 phr to about 5.0 phr. The curing or vulcanizing agents can include, but are not limited to, elemental sulfur, a sulfur-containing silane, or a combination thereof.

In one aspect, the method can further comprise, mixing the initial mixture at a temperature of at least about 100° C., thereby forming a first stage mixture; combining together the first stage mixture with a curing agent, thereby forming an intermediate mixture; and mixing the intermediate mixture at a temperature of at least about 80° C., thereby forming a second stage mixture. In another aspect, the initial mixture can be mixed at a temperature of about 100° C. to about 180° C., about 120° C. to about 180° C., about 130° C. to about 180° C., about 100° C. to about 170° C., or about 100° C. to about 160° C. In another aspect, the intermediate mixture can be mixed at a temperature of about 80° C. to about 110° C., about 90° C. to about 110° C., or about 80° C. to about 100° C. In one aspect, the various mixing stages can comprise thermomechanical mixing, generally characterized by mechanical working in a mixer (e.g., internal batch mixer) or extruder for a period of time at an elevated temperature suitable to produce a rubber. The appropriate duration of the thermomechanical mixing varies as a function of the operating conditions and the volume and nature of the components. For example, the thermomechanical mixing may be from about 0.5 to about 10 minutes.

This disclosure also provides for articles that incorporate any of the vulcanized rubber compositions disclosed herein or are produced by any of the methods disclosed herein. In one aspect, the article comprises a tire, such as a pneumatic tire, or a component of a tire. The tire can be a race tire, passenger tire, aircraft tire, agricultural tire, off-the-road tire, truck or bus tire, or the like. The tire can also be a radial or bias. The component of the tire can be a tread, base, sidewall, apex, chafer, sidewall insert, overlay, wirecoat, innerliner, or a combination thereof. In another aspect, the component of the tire including the composition can be a tread, base, sidewall, apex, overlay, wirecoat, ply coat, shoulder wedge, chafer, or a combination thereof. Vulcanization of the disclosed tires is generally carried out at conventional temperatures ranging from about 100° C. to about 200° C. or from about 110° C. to about 180° C. Such tires can be built, shaped, molded and cured by various methods which are known and will be readily apparent to those having skill in such art.

The articles disclosed herein can have a stiffness that is at least about 10%, at least about 15%, or at least about 20% higher than the stiffness of an equivalent article that does not comprise the turbostratic graphene. In another aspect, the disclosed articles can have a stiffness that is from about 10% to about 20%, about 10% to about 15%, or about 15% to about 20% higher than the stiffness of an equivalent article that does not comprise the turbostratic graphene. The stiffness can be indicated by the dynamic storage shear modulus (G′) of the article, measured at a dynamic strain amplitude of 1%, 10%, 100%, or 140%, at a temperature of about 100° C., and a frequency of about 1 Hz. Dynamic storage shear modulus of a rubber composition measured before or after cure can be performed using a rubber process analyzer, for example, in accordance with ASTMD5289-19a.

In another aspect, the disclosed articles can have an abrasion loss that is at least about 10%, at least about 15%, at least about 20%, or at least about 25% lower than the abrasion loss of an equivalent article that does not comprise the turbostratic graphene. In another aspect, the disclosed articles can have an abrasion loss that is from about 10% to about 30% or about 15% to about 30% lower than the abrasion loss of an equivalent article that does not comprise the turbostratic graphene.

In another aspect, the disclosed articles can have a tear strength that is at least about 10%, at least about 15%, or at least about 20% higher than the tear strength of an equivalent article that does not comprise the turbostratic graphene. In another aspect, the disclosed articles can have a tear strength that is from about 10% to about 30%, about 15% to about 30%, or about 15% to about 25% higher than the tear strength of an equivalent article that does not comprise the turbostratic graphene. The tear strength can be indicated by the Instron tear of the article measured at 95° C. (in accordance with ASTM D624) or the Strebler tear of the article measured at 100° C.

In another aspect, the disclosed articles can have a thermal conductivity that is at least about 5% or at least about 10% higher than the thermal conductivity of an equivalent article that does not comprise the turbostratic graphene. In another aspect, the disclosed articles can have a thermal conductivity that is from about 5% to about 15%, about 5% to about 10%, or about 10% to about 15% higher than the thermal conductivity of an equivalent article that does not comprise the turbostratic graphene. In one aspect, the thermal conductivity is measured using a Hot Disk Thermal Conductivity Analyzer at ambient temperature (about 23° C.).

Instead of incorporating the turbostratic graphene into a polymer masterbatch which is then incorporated into a rubber composition, a rubber composition containing the turbostratic graphene can be formed by adding turbostratic graphene directly (i.e., without a carrier) or as a dispersion in a carrier such as an oil or a resin. In one aspect, the disclosed articles can have improved rheological properties compared to similar articles comprising a turbostratic graphene that was incorporated into the article without a carrier and/or with a carrier such as an oil or resin. Improvements can include higher stiffness, higher modulus, better rolling resistance (measured as higher rebound), higher tear resistance, lower abrasion loss, higher thermal conductivity, or a combination thereof. Further details regarding methods for testing the various properties of the compositions can be found in the Examples.

### D. ASPECTS

The following listing of exemplary aspects supports and is supported by the disclosure provided herein.

Aspect 1. A method for mixing rubber, comprising: combining together a first diene elastomer and a polymer masterbatch, thereby forming an initial mixture; wherein the polymer masterbatch comprises from about 1 phr to about 25 phr of a turbostratic graphene and a second diene elastomer.

Aspect 2. The method of aspect 1, wherein the polymer masterbatch comprises from about 20% to about 40% of the turbostratic graphene by weight.

Aspect 3. The method of aspect 1 or aspect 2, wherein forming the initial mixture further comprises combining together the second diene elastomer with the first diene elastomer and the polymer masterbatch.

Aspect 4. The method of any one of aspects 1-3, wherein the first diene elastomer comprises repeat units formed from residues of monomers selected from ethylene, propylene, isobutene, butadiene, isoprene, styrene, and acrylonitrile, and a combination thereof.

Aspect 5. The method of any one of aspects 1-3, wherein the first diene elastomer comprises repeat units formed from residues of monomers selected from butadiene, isoprene, styrene, and a combination thereof.

Aspect 6. The method of any one of aspects 1-5, wherein the second diene elastomer comprises repeat units formed from residues of monomers selected from ethylene, propylene, isobutene, butadiene, isoprene, styrene, acrylonitrile, and a combination thereof.

Aspect 7. The method of any one of aspects 1-5, wherein the second diene elastomer comprises repeat units formed from residues of monomers selected from butadiene, isoprene, styrene, and a combination thereof.

Aspect 8. The method of any one of aspects 1-7, wherein the first diene elastomer and the second diene elastomer are the same.

Aspect 9. The method of any one of aspects 1-8, wherein the first diene elastomer is different from the second diene elastomer.

Aspect 10. The method of any one of aspects 1-9, wherein the method further comprises combining together at least one of a filler, an antidegradant, a resin, or a processing oil to form the initial mixture.

Aspect 11. The method of any one of aspects 1-10, wherein the filler is used to form the initial mixture, wherein the filler is selected from carbon black, a precipitated silica, or a combination thereof.

Aspect 12. The method of any one of aspects 1-11, wherein the turbostratic graphene comprises less than about 25% oxygen by weight.

Aspect 13. The method of any one of aspects 1-12, wherein the turbostratic graphene comprises from about 0.1% to about 25% oxygen by weight.

Aspect 14. The method of any one of aspects 1-11, wherein the turbostratic graphene comprises no oxygen.

Aspect 15. The method of any one of aspects 1-14, wherein the turbostratic graphene comprises more than about 75% carbon by weight.

Aspect 16. The method of any one of aspects 1-15, wherein the turbostratic graphene comprises from about 75% to about 100% carbon by weight.

Aspect 17. The method of any one of aspects 1-16, wherein the turbostratic graphene has peaks at 1880 cm-1 and 2030 cm-1, as determined by Raman spectroscopy.

Aspect 18. The method of any one of aspects 1-17, wherein the turbostratic graphene does not have a peak at 1750 cm 1, as determined by Raman spectroscopy.

Aspect 19. The method of any one of aspects 1-19, wherein the turbostratic graphene has a 2D-band peak intensity to G-band peak intensity ratio of at least about 0.5, as determined by Raman spectroscopy.

Aspect 20. The method of any one of aspects 1-19, wherein the turbostratic graphene has a 2D-band peak intensity to G-band peak intensity ratio of from about 0.5 to about 17, as determined by Raman spectroscopy.

Aspect 21. The method of any one of aspects 1-20, wherein the turbostratic graphene has a D-band peak intensity to G-band peak intensity ratio of no more than about 1, as determined by Raman spectroscopy.

Aspect 22. The method of any one of aspects 1-20, wherein the turbostratic graphene has a D-band peak intensity to G-band peak intensity ratio of about 0.01 to about 1, as determined by Raman spectroscopy.

Aspect 23. The method of any one of aspects 1-22, further comprising: mixing the initial mixture at a temperature of at least about 100° C., thereby forming a first stage mixture; combining together the first stage mixture with a curing agent, thereby forming an intermediate mixture; and mixing the intermediate mixture at a temperature of at least about 80° C., thereby forming a second stage mixture.

Aspect 24. The method of aspect 23, further comprises combining together at least one of a coupling agent, an accelerator, or a retarder to form the intermediate mixture.

Aspect 25. The method of aspect 23 or aspect 24, wherein the initial mixture is mixed at a temperature of about 130° C. to about 180° C.

Aspect 26. The method of any one of aspects 23-25, wherein the intermediate mixture is mixed at a temperature of about 90° C. to about 110° C.

Aspect 27. An article produced using the method of aspect 1.

Aspect 28. The article of aspect 27, wherein the article comprises a tire or a component of a tire.

Aspect 29. The article of aspect 28, wherein the component of the tire comprises a tread, base, sidewall, apex, wirecoat, ply coat, shoulder wedge, chafer, or any combination thereof.

Aspect 30. The article of any one of aspects 27-29, wherein the article has a stiffness that is at least about 10% higher than the stiffness of an equivalent article that does not comprise the turbostratic graphene; and wherein the stiffness is indicated by the dynamic storage shear modulus (G′) of the article, measured at a dynamic strain amplitude of 1%, 10%, 100%, or 140%, at a temperature of about 100° C., and a frequency of about 1 Hz.

Aspect 31. The article of any one of aspects 27-30, wherein the article has an abrasion loss that is at least about 15% lower than the abrasion loss of an equivalent article that does not comprise the turbostratic graphene.

Aspect 32. The article of any one of aspects 27-31, wherein the article has a tear strength that is at least about 10% higher than the tear strength of an equivalent article that does not comprise the turbostratic graphene; and wherein the tear strength is indicated by the Instron tear of the article measured at 95° C.

Aspect 33. The article of any one of aspects 27-32, wherein the article has a thermal conductivity that is at least about 5% higher than the thermal conductivity of an equivalent article that does not comprise the turbostratic graphene.

From the foregoing, it will be seen that aspects herein are well adapted to attain all the ends and objects hereinabove set forth together with other advantages which are obvious, and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein. It will be understood that certain features and subcombinations are of utility and may be employed without reference to other features and subcombinations. This is contemplated by and is within the scope of the claims. Since many possible aspects may be made without departing from the scope thereof, it is to be understood that all matter herein set forth or shown in the accompanying detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text, there is no intent to limit aspects of the present disclosure to this description. On the contrary, the intent is to cover all alternatives, modifications, and equivalents included within the spirit and scope of the present disclosure.

### E. EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Evaluation of Rubber Compositions

Three representative rubber compositions comprising a styrene butadiene rubber and natural rubber-based matrix are provided in Table 1. Notable differences between the compositions include the presence of turbostratic graphene and how the turbostratic graphene is incorporated into the compositions. For Experimental A, turbostratic graphene is incorporated as a dispersion of 50% turbostratic graphene by weight in naphthenic oil. For Experimental B, turbostratic graphene is first dispersed in a polymer masterbatch (30% by weight turbostratic graphene in ESBR type 1502) and the resulting mixture is then added to the rubber composition.

TABLE 1
Representative rubber compositions with ingredient
amounts given in phr.

| | Control | Experimental | Experimental |
|---|---|---|---|
| Ingredients | A | A | B |
| Natural Rubber | 80 | 80 | 80 |
| ESBR¹ | 20 | 20 | 20 |
| Carbon Black² | 48 | 48 | 48 |
| Naphthenic Oil | 5 | 5 | 0 |
| Turbostratic Graphene³ | 0 | 5 | 0 |
| Turbostratic Graphene⁴ | 0 | 0 | 6 |

¹Available as PLF1502 from Goodyear Chemical
²ASTM N220 Carbon Black
³Turbostratic graphene as a dispersion of 50% by weight in naphthenic oil (oil content included in total oil reported)
⁴Turbostratic graphene as a pre-dispersed polymer masterbatch of 30% by weight in ESBR Type 1502 (polymer content included in total polymer reported)

Table 2 provides an overview of rheological properties of the rubber compositions provided in Table 1. Compared to composition Control A, both composition Experimental A and composition Experimental B exhibit greater stiffness (RPA G′), with Experimental B exhibiting greater stiffness than Experimental A. Additionally, both experimental compositions exhibit a greater modulus than the control compositions, with Experimental B exhibiting greater modulus than Experimental A. Experimental B also exhibits improved tear properties (Instron tear and Strebler tear), better treadwear (indicated by lower abrasion loss at both medium and high severity), better thermal conductivity, and similar thermal diffusivity compared to Control A. Overall, the inclusion of turbostratic graphene in the rubber composition results in improvements in various rheological properties of the rubber. Incorporating turbostratic graphene into the rubber composition specifically via a pre-dispersed polymer masterbatch shows overall greater enhancements in properties such as tear, abrasion resistance, thermal conductivity, and compound stiffness.

TABLE 2
Rheological properties for representative rubber compositions
of Table 1. Values for Experimental compositions A and B are
normalized compared to Control composition A.

| | | Con- | Experi- | Experi- |
|---|---|---|---|---|
| | | trol | mental | mental |
| | Property | A | A | B |
| Cure | Delta Torque MDR | 100% | 106% | 110% |
| | 150° C. | | | |
| Stiffness, | RPA G′ 1% (MPa) | 100% | 120% | 127% |
| Hardness | RPA G′ 10% (MPa) | 100% | 111% | 116% |
| | RPA G′ 100% (MPa) | 100% | 105% | 108% |
| | RPA G′ 140% (MPa) | 100% | 105% | 107% |
| Modulus, | Elongation (Die C, %) | 100% | 92% | 89% |
| Tensile, | Tensile (Die C, MPa) | 100% | 95% | 89% |
| Elongation | 100% Modulus (Die C, | 100% | 106% | 119% |
| | MPa) | | | |
| | 300% Modulus (Die C, | 100% | 106% | 118% |
| | MPa) | | | |
| Hysteresis/ | Rebound 100° C., Higher | 100% | 95% | 99% |
| Rolling | is Better | | | |
| Resistance | RPA TD 10%, Lower is | 100% | 107% | 114% |
| | Better | | | |
| Tear | Instron Tear w/ Backing | 100% | 93% | 114% |
| | 95° C. (N/mm) | | | |
| | Strebler Tear 100° C. | 100% | 219% | 128% |
| | (N/mm) | | | |
| Abrasion | Grosch, High Severity | 100% | 89% | 69% |
| Loss | (mg/km) | | | |
| | Grosch, Medium Severity | 100% | 102% | 85% |
| | (mg/km) | | | |
| Conductivity | Thermal Conductivity | 100% | 106% | 109% |
| | (W/m · K) | | | |
| | Thermal Diffusivity | 100% | 108% | 101% |
| | (mm²/S) | | | |

Three additional representative rubber compositions comprising a styrene butadiene rubber and a high cis polybutadiene rubber-based matrix are provided in Table 3. Notable differences between the compositions include the presence of turbostratic graphene and/or carbon black, and the amount of each component incorporated into the composition, when present. For both composition Experimental C and composition Experimental D, the turbostratic graphene is first dispersed in a polymer masterbatch (30% by weight turbostratic graphene in a high cis polybutadiene) and the resulting mixture is then added to the rubber composition.

TABLE 3
Representative rubber compositions with ingredient
amounts given in phr.

| | | Experi- | Experi- |
|---|---|---|---|
| Ingredient | Control B | mental C | mental D |
| SSBR¹ | 62 | 62 | 62 |
| High cis Polybutadiene² | 38 | 38 | 38 |
| Turbostratic Graphene³ | 0 | 7 | 10 |
| Carbon Black | 4 | 5 | 0 |
| Precipitated Silica⁴ | 95 | 80 | 85 |
| Mercapto Silane | 7.5 | 6.4 | 6.8 |
| Naphthenic Oil | 27 | 23 | 23 |
| Petroleum Hydrocarbon | 7.5 | 10 | 10 |
| Resin⁵ | | | |

¹Functionalized w/ medium styrene (21)/high vinyl microstructure (50)
²Obtained from The Goodyear Tire & Rubber Company as Budene1223
³Turbostratic graphene as a pre-dispersed polymer masterbatch of 30% by weight in Budene1223 (polymer content included in total polymer reported)
⁴BET 160 m²/g
⁵Hydrogenated, aromatic (C9) modified dicyclopentadiene (DCPD) petroleum hydrocarbon resin

Table 4 provides an overview of rheological properties of the rubber compositions provided in Table 3. Composition Experimental D exhibit greater stiffness (RPA G′) than composition Experimental C. Experimental D includes more turbostratic graphene than Experimental C and contains no carbon black. Both experimental compositions exhibit better abrasion resistance and better hysteresis/rolling resistance compared to composition Control B. The higher rebound and lower tangent delta (TD) values contribute to improved hysteresis/rolling resistance. Experimental C exhibits improved tear resistances (measured by Instron tear and Strebler adhesion) compared to Control B. Experimental C exhibits improved mechanical properties of tensile strength, and elongation at break compared to Control B. Experimental D exhibits similar or improved mechanical properties of modulus, tensile strength, and elongation at break compared to Control B. Overall, the inclusion of turbostratic graphene in the rubber composition via a pre-dispersed polymer masterbatch results in improvements in various rheological properties of the rubber. Generally, the presence or absence of carbon black can affect how much various rheological properties improve for the compositions comprising turbostratic graphene.

TABLE 4
Rheological properties for representative rubber compositions
of Table 3. Values for Experimental compositions C and D are
normalized compared to Control composition B.

| | | | Experi- | Experi- |
|---|---|---|---|---|
| | Property | Control B | mental C | mental D |
| | Specific Gravity (g/cm³) | 100% | 99% | 100% |
| Cure | Delta Torque MDR | 100% | 82% | 92% |
| | 150° C. | | | |
| Stiffness | RPA G′ 1% (MPa) | 100% | 75% | 84% |
| | RPA G′ 10% (MPa) | 100% | 84% | 94% |
| | RPA G′ 50% (MPa) | 100% | 89% | 98% |
| | ARES G′ 1%, 30° C. | 100% | 71% | 77% |
| | (MPa) | | | |
| | ARES G′ 10%, 30° C. | 100% | 80% | 92% |
| | (MPa) | | | |
| Wet | Rebound 0%, Lower is | 100% | 101% | 106% |
| Indicator | Better | | | |
| Hysteresis/ | Rebound 23%, Higher is | 100% | 113% | 116% |
| Rolling | Better | | | |
| resistance | Rebound 60%, Higher is | 100% | 103% | 110% |
| | Better | | | |
| | Rebound 100%, Higher | 100% | 100% | 105% |
| | is Better | | | |
| | ARES TD 10%, Lower is | 100% | 96% | 81% |
| | Better | | | |
| | RPA TD 10%, Lower is | 100% | 95% | 88% |
| | Better | | | |
| Hardness | Shore A (0° C.) | 100% | 96% | — |
| | Shore A (23° C.) | 100% | 96% | 96% |
| | Shore A (1000° C.) | 100% | 95% | 97% |
| Modulus, | 100% Modulus (Die C, | 100% | 85% | 100% |
| Tensile, | MPa) | | | |
| Elongation | 300% Modulus (Die C, | 100% | 86% | 103% |
| at Break | MPa) | | | |
| | Tensile (Die C, MPa) | 100% | 111% | 119% |
| | Elongation at Break (%) | 100% | 119% | 111% |
| Tear | Strebler Adhesion to Self | 100% | 183% | 96% |
| Resistance | (N/mm) | | | |
| | Instron Bulk Tear w/ | 100% | 127% | 89% |
| | Backing (N/mm) | | | |
| Abrasion | Grosch, High Severity | 100% | 96% | 96% |
| Loss | (mg/km) | | | |
| | Grosch, Medium Severity | 100% | 95% | 95% |
| | (mg/km) | | | |
| | DIN Relative Volume | 100% | 91% | 91% |
| | Loss | | | |

For properties of the cured rubber compositions provided in Table 2, the rubber compositions were cured in a testing cavity at a temperature of 135° C. for 140 minutes prior to testing. For properties of the cured rubber compositions provided in Table 4, the rubber compositions were cured in a testing cavity at a temperature of 170° C. for 10 minutes prior to testing.

Cure properties can be determined using a moving die rheometer (MDR) operated at a temperature of 150° C. and at a frequency of 11 hertz. A description of oscillating disc rheometers can be found in The Vanderbilt Rubber Handbook edited by Robert O. Ohm (Norwalk, Conn., R. T. Vanderbilt Company, Inc., 1990), Pages 554 through 557. The use of this cure meter and standardized values read from the curve are specified in ASTM D-2084. A typical cure curve obtained on an oscillating disc rheometer is shown on Page 555 of the 1990 edition of The Vanderbilt Rubber Handbook.

Viscoelastic properties (G′ and tan delta TD) can be measured using an ARES Rotational Rheometer rubber analysis instrument, which is an instrument for determining various viscoelastic properties of rubber samples, including their storage modulii (G′) over a range of in torsion as measured at 3% strain and a frequency of 10 Hz. Generally, a higher G′ at 30° C. indicates a better handling performance for a tire containing the given compound. Tan delta is given as measured at 10% strain and a frequency of 10 Hz at 0° C. Generally, a higher tan delta at 0° C. indicates improved wet traction in a tire containing the given compound. Other viscoelastic properties (RPA G′ and RPA TD) can be determined using a Flexsys Rubber Process Analyzer (RPA) 2000. A description of the RPA 2000, its capability, sample preparation, tests and subtests can be found in these references: H. A. Pawlowski and J. S. Dick, Rubber World, June 1992; J. S. Dick and H. A. Pawlowski, Rubber World, January 1997; and J. S. Dick and H. A. Pawlowski, Rubber & Plastics News, April 26 and May 10, 1993.

The Zwick Rebound test can be used to determine the resilience of rubber, within a range of impact strain and strain rate, by means of the impacting and measuring apparatus conforming to the requirements described in the test method according to ASTM D7121 or ASTM D1054. The test is conducted at a sample temperature of 100° C. Resilience is recorded as pendulum rebound height after the pendulum hits a rubber sample. The higher the rebound value, the less energy is loss due to the pendulum's impact on the rubber sample. At 100° C., higher rebound can be associated with a lower tire rolling resistance.

A cured/vulcanized rubber composition's tensile mechanical properties such as tensile stress, modulus at various strains, and elongation at break, can be measured using the ASTM D412 test procedure. Briefly, a Die C dumbbell shaped rubber sample of known dimensions is placed in an extensometer and then clamped in grips of a force displacement machine. The rubber sample is pulled at a set rate of 500 mm/min until it breaks. Elongation at break refers to the percentage of the original length of a rubber or elastomeric material to which the material is extended at rupture, when the material is subjected to a stretching or tensile force. Shore A hardness can be measured according to ASTM D2240.

The Strebler adhesion test measures the interfacial adhesion of cured rubber compounds. The interfacial adhesion is measured by pulling a sample in a T-peel manner using a force displacement machine. A defined area, or window, created by a mask between the surfaces of the sample is subjected to the test. Samples may consist of two layers of the same compound, or two different compounds adhered together (Global Strebler), to determine the adhesion between rubbers. Variations in surface treatment can also be used (such as fabric, Global Fabric Strebler) to determine the adhesion between rubber and fabric. The higher the force to peel off, the higher adhesion. For the tests reported herein, a pulling speed of 500 mm/min was used along with a curing pressure of 100 psi.

Thermal conductivity can be measured by a Hot Disk Thermal Conductivity Analyzer, Hot Disk TPS 2500, with Probe Type 5501. The test can be conducted at ambient temperature (about 23° C.). The thermal conductivity unit is expressed as Watts/meter/Kelvin degrees temperature.

Abrasion loss can be measured as the Grosch abrasion loss at either medium or high severity. In one aspect, abrasion loss can be determined as Grosch abrasion rate as run on a LAT-100 Abrader and measured in terms of mg/km of rubber abraded away. The test rubber sample is placed at a slip angle under constant load (Newtons) as it traverses a given distance on a rotating abrasive disk (disk from HB Schleifmittel GmbH). A high abrasion severity test may be run, for example, at a load of 70 newtons, 12° slip angle, and disk speed of 20 km/hr for a distance of 250 meters.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method for mixing rubber, comprising:
combining together a first diene elastomer and a polymer masterbatch, thereby forming an initial mixture;
wherein the polymer masterbatch comprises from about 1 phr to about 25 phr of a turbostratic graphene and a second diene elastomer.

2. The method of claim 1, wherein the polymer masterbatch comprises from about 20% to about 40% of the turbostratic graphene by weight.

3. The method of claim 1, wherein the first diene elastomer and the second diene elastomer individually comprise repeat units formed from residues of monomers selected from ethylene, propylene, isobutene, butadiene, isoprene, styrene, and acrylonitrile, and a combination thereof.

4. The method of claim 1, wherein the method further comprises combining together at least one of a filler, an antidegradant, a resin, a coupling agent, or a processing oil to form the initial mixture.

5. The method of claim, wherein the filler is used to form the initial mixture, wherein the filler is selected from carbon black, a precipitated silica, or a combination thereof.

6. The method of claim 1, wherein the turbostratic graphene comprises less than about 25% oxygen by weight.

7. The method of claim 1, wherein the turbostratic graphene has peaks at 1880 cm-1 and 2030 cm-1, as determined by Raman spectroscopy.

8. The method of claim 1, wherein the turbostratic graphene has a 2D-band peak intensity to G-band peak intensity ratio of at least about 0.5, as determined by Raman spectroscopy.

9. The method of claim 1, wherein the turbostratic graphene has a D-band peak intensity to G-band peak intensity ratio of no more than about 1, as determined by Raman spectroscopy.

10. The method of claim 1, further comprising:
mixing the initial mixture at a temperature of at least about 100° C., thereby forming a first stage mixture;
combining together the first stage mixture with a curing agent, thereby forming an intermediate mixture; and
mixing the intermediate mixture at a temperature of at least about 80° C., thereby forming a second stage mixture.

11. The method of claim, further comprising combining together at least one of an accelerator or a retarder to form the intermediate mixture.

12. The method of claim, wherein the initial mixture is mixed at a temperature of about 130° C. to about 180° C.

13. The method of claim, wherein the intermediate mixture is mixed at a temperature of about 90° C. to about 110° C.

14. An article produced using the method of claim 1.

15. The article of claim, wherein the article comprises a tire or a component of a tire.

16. The article of claim, wherein the component of the tire comprises a tread, base, sidewall, apex, wirecoat, ply coat, shoulder wedge, chafer, or any combination thereof.

17. The article of claim, wherein the article has a stiffness that is at least about 10% higher than the stiffness of an equivalent article that does not comprise the turbostratic graphene; and wherein the stiffness is indicated by the dynamic storage shear modulus (G′) of the article, measured at a dynamic strain amplitude of 1%, 10%, 100%, or 140%, at a temperature of about 100° C., and a frequency of about 1 Hz.

18. The article of claim, wherein the article has an abrasion loss that is at least about 15% lower than the abrasion loss of an equivalent article that does not comprise the turbostratic graphene.

19. The article of claim, wherein the article has a tear strength that is at least about 10% higher than the tear strength of an equivalent article that does not comprise the turbostratic graphene; and wherein the tear strength is indicated by the Instron tear of the article measured at 95° C.

20. The article of claim, wherein the article has a thermal conductivity that is at least about 5% higher than the thermal conductivity of an equivalent article that does not comprise the turbostratic graphene.
